(19) United States
(12) Patent Application Publication
(10) Pub. No.: US 2022/0292937 A1
(43) Pub. Date: Sep. 15, 2022

(54) Hearing Aid Cover

(71) Applicant: Kim Redman, Erin, TN (US)

(72) Inventor: Kim Redman, Erin, TN (US)

(21) Appl. No.: 17/400,234

(22) Filed: Aug. 12, 2021

Related U.S. Application Data
(60) Provisional application No. 63/159,094, filed on Mar. 10, 2021.

(51) Int. Cl. G08B 5/36; G06F 3/01; G08B 3/10; H04R 25/00

(52) U.S. Cl. CPC G08B 5/36; G06F 3/016; G08B 3/10; H04R 25/65; H04R 25/554; H04R 2225/55

(57) ABSTRACT

The present invention relates to a hearing aid cover. More specifically, the present invention relates to an improved hearing aid cover that has a speaker, a light emitting feature, a transmitter beacon, a mobile application, and a wrist-worn locating device, which all aid a user in locating the cover and any attached hearing aid in the event that they are lost or otherwise misplaced. The mobile application includes a display that aids a user in locating the cover, and the locating device can be worn on the wrist of a user such that a vibrating motor increases in intensity when a user gets closer to the device.

### CROSS-REFERENCE TO RELATED APPLICATION

The present application claims priority to, and the benefit of, U.S. Provisional Application No. 63/159,094, which was filed on Mar. 10, 2021 and is incorporated herein by reference in its entirety.

### FIELD OF THE INVENTION

The present invention relates generally to the field of protective covers. More specifically, the present invention relates to an improved hearing aid cover that has a speaker, a laser, a transmitter beacon, a mobile application and a wrist-worn locating device which all aid a user in locating the cover and any attached hearing aid in the event that they are both lost. In use, the speaker produces a loud sound and the laser produces a visual laser which can both be controlled by the mobile application and can be activated by the locating device. The mobile application further includes a display that aids a user in locating the device and the locating device, which includes a vibrating motor that increases in intensity when a user gets closer to the lost device and can be worn on a user's wrist. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Hearing loss is the third most common chronic physical condition behind arthritis and heart disease. As a result, approximately one in three people in the United States between the ages of 65 and 74 have hearing loss, while nearly half of those older than 75 have difficulty hearing. To combat hearing loss, 30 percent of adults over 70 use hearing aids or some other form of hearing assistance device.

Hearing aid users often find themselves readjusting or reinserting their hearing aids because the position of the hearing aid(s) has shifted or they have become dislodged from the inserted position during use. This shifting of position can occur due to a number of factors, including the repositioning and movement of glasses that a user may be wearing which dislodge the hearing aids as well as other activities in which a wearer may engage in. Further, hearing aids may shift in position on their own during their normal course of use. This is not desirable for users, as they must constantly readjust and reinsert their hearing aids as needed throughout the day, which may be difficult if they also suffer from decreased dexterity or may be in a location where subsequent adjustment is not possible.

Further, hearing aids are frequently lost or misplaced by users due to their small size and otherwise inconspicuous nature. When this occurs, the user's quality of life may be significantly diminished as they cannot properly hear those in their surrounding environment. Further, they often cannot hear adequately until their replacement hearing aid arrives. In addition, the financial costs of replacing a hearing aid can be significant, with most hearing aids costing upwards of $1,000 USD. Therefore, it is not economically desirable for a user to lose a hearing aid. In addition, a user may waste time looking for a lost hearing aid, which can also be extremely frustrating.

Therefore, there exists a long-felt need in the art for an improved hearing aid cover and locating device. There also is a long-felt need in the art for an improved hearing aid cover that better secures a hearing aid within the ear canal of a user such that the hearing aid does not have to be regularly repositioned or reinserted throughout the day, especially when a user is wearing glasses or is engaged in various activities. Finally, there is a long-felt need in the art for an improved hearing aid cover that aids a user in locating a lost or misplaced hearing aid.

The subject matter disclosed and claimed herein, in one embodiment thereof, comprises an improved hearing aid cover. The cover has a body that slides over the existing body of a hearing aid and also allows the hearing aid body to be attached to the arm of a pair of eyeglasses. Further, the cover may have integrated locating technology that includes a transmitter beacon, a laser and a speaker that all aid a user in locating the cover and any attached hearing aid in the event that a hearing aid is lost with a cover attached. The device may also include a mobile application and wrist-worn locating device that aids a user in finding both the device and attached hearing aid if either have been lost.

In this manner, the improved hearing aid cover device of the present invention accomplishes all of the forgoing objectives and provides an improved hearing aid cover that can be better secured in the ear of a user, especially when the user is wearing glasses. Further, the improved hearing aid cover of the present invention aids a user in locating the device and any attached hearing aid if either is lost via a plurality of locating features. Accordingly, the features include a transmitter beacon, a laser, and a speaker, as well as a mobile application and wrist-worn locating device.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an improved hearing aid cover. The cover is preferably made from a flexible or semi-rigid body that can be slid over the body of a hearing aid. The cover has a plurality of features on its side surfaces. The side surface includes a speaker which can be controlled via a mobile application or wrist-worn locating device to play a loud sound such that a user can easily locate the lost cover and hearing aid. Further, the side surface may use a visible laser. The laser (or in a differing embodiment, an LED) can be controlled via a mobile application or wrist-worn locating device, such that the laser or LED is illuminated when the cover has been lost and after the user has activated the feature when searching for the missing hearing aid. In this manner, the laser will project onto nearby surfaces such that a user may more easily observe the location of the lost cover and enclosed hearing aid. In addition, the side surface may include a transmitter beacon that allows the cover and enclosed hearing aid to easily be found by a user via a mobile application or wrist-worn locating device. To accomplish this, the transmitter beacon contains a form of wireless transmitter or wireless communication module that allows the device to communicate with the mobile application or wrist-worn locating device via a wireless electrical communication such as Bluetooth, Wi-Fi, RFID, etc. The side surface of the cover may also have a magnetic plate which allows the cover to be easily retained on the frame arm of a pair of metal eyeglasses.

Accordingly, the improved hearing aid cover of the present invention is particularly advantageous as it allows a user to comfortably wear hearing aids with a pair of eyeglasses, which would otherwise typically cause a hearing aid to dislodge from a user's ear or cause a hearing aid to need to be readjusted and reinserted. Further, the improved hearing aid cover of the present invention ensures that the cover and any attached or enclosed hearing aid can be easily located. As such, the device provides a plurality of location-aiding features in the form of a transmitter beacon, a laser, and a speaker, as well as a mobile application and wrist-worn locating device to aid the user in finding the cover and the attached or enclosed hearing aid if lost.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a hearing aid cover of the present invention attached around a hearing aid in accordance with the disclosed architecture;

FIG. 2 illustrates a perspective view of another potential embodiment of the hearing aid cover of the present invention enclosing a hearing aid in accordance with the disclosed architecture;

FIG. 3 illustrates a perspective view of another potential embodiment of the hearing aid cover of the present invention enclosing a hearing aid in accordance with the disclosed architecture;

FIG. 4A illustrates a perspective view of another potential embodiment of the hearing aid cover of the present invention enclosing a hearing aid and attached to a pair of eyeglasses in accordance with the disclosed architecture;

FIG. 4B illustrates a perspective view of another potential embodiment of a hearing aid cover of the present invention enclosing a hearing aid and attached to a pair of eyeglasses in accordance with the disclosed architecture;

FIG. 5 illustrates a perspective view of a wrist-worn locating device of one potential embodiment of the hearing aid cover of the present invention in accordance with the disclosed architecture;

FIG. 6 illustrates a perspective view of a mobile application used in conjunction with one potential embodiment of the hearing aid cover of the present invention in accordance with the disclosed architecture; and

FIG. 7 illustrates a schematic diagram of the various modules used in connection with one potential embodiment of the hearing aid cover of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved hearing aid cover device. Specifically, there is a long-felt need in the art for an improved hearing aid cover that better secures a hearing aid within the ear canal of a user such that the hearing aid does not have to be regularly repositioned or reinserted throughout the day, especially when a user may be wearing glasses. Further, there is a long-felt need in the art for an improved hearing aid cover that aids a user in locating a lost or misplaced hearing aid to avoid the costly expense of replacing a lost hearing aid.

The present invention, in one exemplary embodiment, includes an improved hearing aid cover. The cover is preferably constructed from a flexible or semi-rigid body sleeve that can be slid over the body or housing of a hearing aid. The cover further includes a plurality of features on its side or exterior surfaces, such as a speaker which can be controlled via a mobile application or wrist-worn locating device to activate the speaker to play a loud sound such that a user can easily locate the lost cover and enclosed hearing aid. Further, the side surface may have a visible laser or in a differing embodiment, an LED emitting device, that can be controlled via a mobile application or wrist-worn locating device such that the laser or LED is illuminated when the cover has been lost and hearing aid. In this manner, the laser or LED will project onto nearby surfaces such that a user may more easily see the location of the lost cover and enclosed hearing aid. In addition, the side surface may have a transmitter beacon that allows the cover and enclosed hearing aid to easily be found by a user via a mobile application wrist-worn locating device. The transmitter beacon contains a form of wireless transmitter or wireless communication module that allows the device to communicate with the mobile application or wrist-worn locating device. This communication may be done via a wireless electrical communication such as Bluetooth, Wi-Fi, RFID, etc. Further, the side or exterior surface of the cover may also include a magnetic plate which allows the cover to easily be retained on the frame arm of a pair of metal eyeglasses.

Accordingly, the improved hearing aid cover of the present invention is particularly advantageous as it allows a user to comfortably wear hearing aids with a pair of eyeglasses, which would otherwise typically cause a hearing aid to dislodge from a wearer's ear or need to be readjusted and reinserted. Further, the improved hearing aid cover of the present invention ensures that the cover and any attached hearing aid cannot be easily lost or otherwise misplaced. As such, the hearing aid cover provides a plurality of location-aiding features in the form of a transmitter beacon, a laser, and a speaker, as well as a mobile application and wrist-worn locating device to aid the user in finding the cover and attached hearing aid if lost.

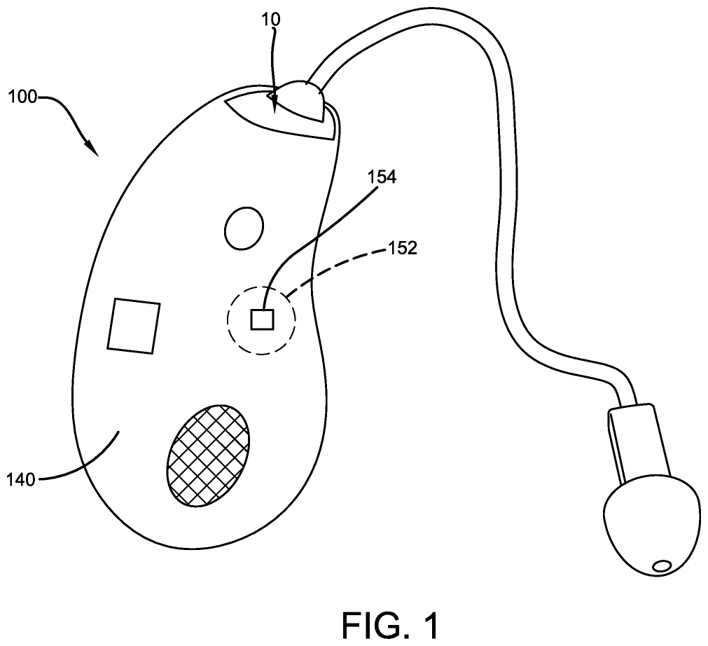

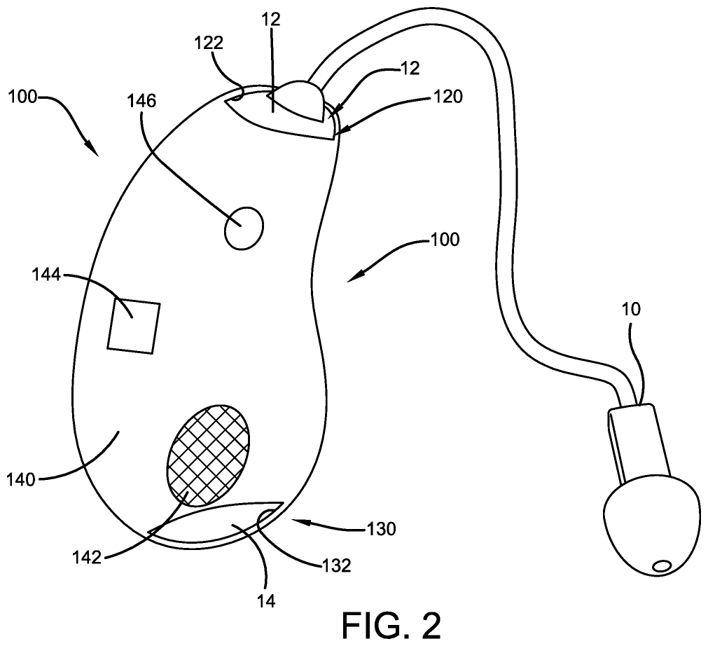

Referring initially to the drawings, FIG. 1 illustrates a perspective view of one potential embodiment of a hearing aid cover 100 of the present invention attached around a hearing aid 10. The hearing aid cover 100 has a body 110 that has a speaker 142, a transmitter beacon 144, and a visible laser 146, as well as a mobile application 200 and wrist-worn locating device 300. The body 110 of the hearing aid cover 100 is preferably constructed from a flexible or semi-rigid continuous sleeve that may be made of nylon, silicone, neoprene or any other synthetic material that has elastic or semi-elastic properties. However, in the preferred embodiment of the hearing aid cover 100, the body 110 includes a flexible body sleeve 110 that can be slid over the body of a hearing aid 10 (e.g., the hearing aid 10 is placed inside and enclosed by the body 110). In differing embodiments of the body 110, the first end 120 and second end 130 of the body 110 may each have a continuous opening 122, 132 that exposes the first end 12 and or second end 14 of a hearing aid 10, as also shown in FIG. 2. This allows various portions of the hearing aid 10 to be accessed for ease of use. Further, it is contemplated that the body 110 of the hearing aid cover 100 may be any oblong shape that mirrors the shape of any hearing aid 10 known in the art, such that the body 110 of any hearing aid 10 can be placed inside the body 110. In another embodiment of the invention, the transmitter beacon 144 can be positioned on the hear aid itself, as opposed to on the cover.

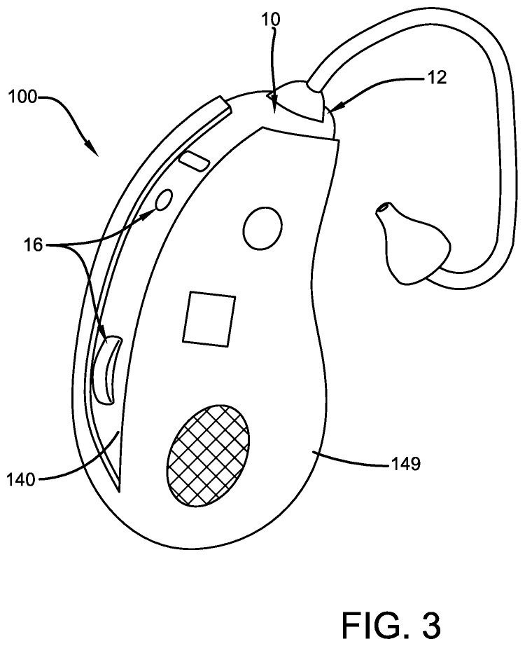

FIG. 3 illustrates a perspective view of a differing potential embodiment of a hearing aid cover 100 of the present invention enclosing and securing a hearing aid 10. In this embodiment of the cover 100, the otherwise continuous body 110 may also have one or more cutaway sections 148 and 149 which expose the controls 16 and speaker, respectively, of a hearing aid 10. Accordingly, this embodiment of the cover 100 allows a user to fully access the controls 16 to properly use and control the hearing aid 10. It is further contemplated that any embodiment of the device 100 may have any number of cutaways 148 at any location of the body 110, such that the controls 16 of a hearing aid 10 may need to be accessed through the body 110.

As seen in FIGS. 1, 2, and 3, the side surface 140 of the body 110 has a plurality of features. These features include but are not limited to: a speaker 142, a transmitter beacon 144, a visible laser 146 and a magnetic plate 150. In any embodiment of the device 100, the device 100 also preferably includes an integrated battery 152 that is located within the body 110 material. As such, the battery 152 provides power to the device 100, and may even supply power to the hearing aid 10 in one embodiment of the cover 100. Further, the body 110 may include a USB charging port 154 that allows for the battery 152 to be charged. In differing embodiments, the charging port 154 may be a plurality of USB charging ports, such as but not limited to: USB-A, USB-B, Micro-B, Micro-USB, Mini-USB, USB-C, etc. It is also contemplated that the battery 152 may be a disposable cell or button battery, such that the cover 100 can then be discarded when the battery 152 runs dead.

The transmitter beacon 144 of the side surface 140 allows the cover 100, once attached hearing aid 10, to be easily found by a user via a mobile application 200 or wrist-worn locating device 300, which will be explained more fully below. However, it is contemplated that the beacon 144 contains a form of wireless transmitter or wireless communication module that allows the device 100 to communicate with the mobile application 200 or wrist-worn locating device 300 via a wireless electrical communication such as Bluetooth, Wi-Fi, RFID, etc.

The side surface 140 is also comprised of a visible laser 146. In differing embodiments, the laser 146 may be any light-emitting laser of any color or may also be an LED light. Accordingly, if the cover 100 and hearing aid 10 that the cover 100 is attached around is lost, a user can activate the laser 146 via the mobile application 200 or a button 328 on the wrist-worn locating device 300, such that the laser or LED 146 is illuminated. In this regard, the laser or LED 146 will project light onto nearby surfaces such that a user will be aided in locating the cover 100 and associated hearing aid if it has been lost or misplaced. In addition, the speaker 142 can also be controlled by the mobile application 200 or a button 328 on the wrist-worn locating device 300 such that it emits a loud tone that may be continuous or semi-continuous (e.g. beeping) such that a user may easily find the cover 100 if it has been lost. Further, the user may use the mobile application 200 to control the specific type, frequency, duration and volume of tone emitted from the speaker 142.

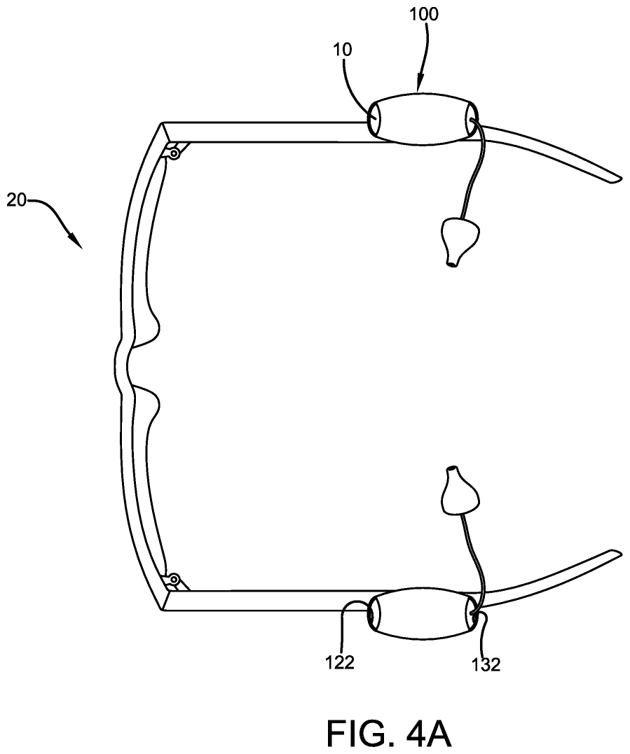

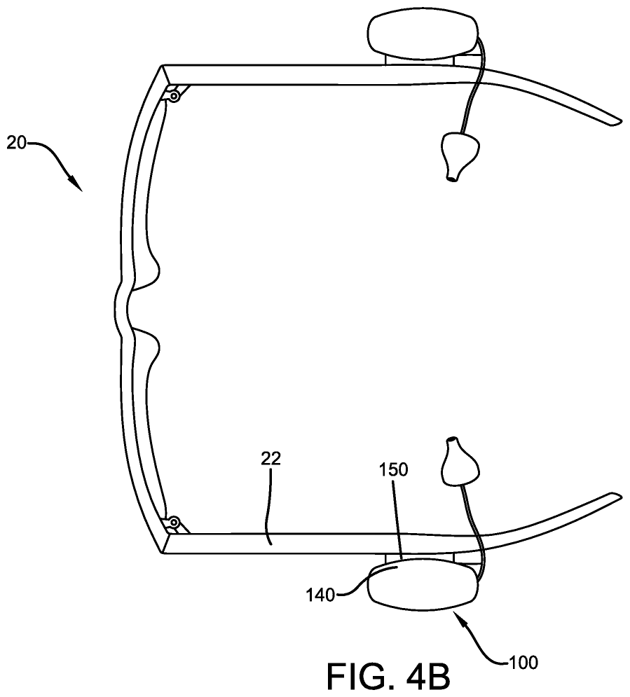

FIG. 4A illustrates a perspective view of a potential embodiment of the hearing aid cover 100 of the present invention attached around a hearing aid 10 that is attached to a pair of eyeglasses 20. As noted supra, wearing a hearing aid 10 with eyeglasses 20 may cause the eyeglasses 20 to frequently dislodge the hearing aid 10 or cause it to have to be regularly repositioned. To combat this, the cover 100 can be attached to the frame arm 22 of a pair of eyeglasses 20. To do so, a user simply slides the cover 100 over a hearing aid 10 and then slides the frame arm 22 through both continuous openings 122, 132 of the body 110, such that the arm 22 completely runs through the body 110 (e.g. through one continuous opening 122 and out the other continuous opening 132, stated differently, a connection element or mechanism). In this manner, the device 100 and hearing aid 10 are now attached (via the elastic force of the body 110) to the frame arm 22 such that the hearing aid 10 and glasses 20 can move in unison and not be displaced, and the glasses 20 will not dislodge the hearing aid 10 from the ear of the wearer.

Alternatively, and as seen in FIG. 4B, the side surface 140 of the body 110 may have an integrated magnetic plate 150. The plate 150 may be implanted within the body 110 material or affixed with adhesive to any portion of the body 110, such that the plate 150 can contact the frame arm 22 of a pair of eyeglasses 20. Ideally, this embodiment of the cover 100 can then be used in conjunction with metal eyeglasses 20, such that the cover 100 and hearing aid 10 can simply be retained on the frame arm 22 via a magnetic field between the frame arm 22 and magnetic plate 150. Therefore, the device 100 and hearing aid 10 can be adequately secured but also easily removed from a pair of eyeglasses 20 as needed.

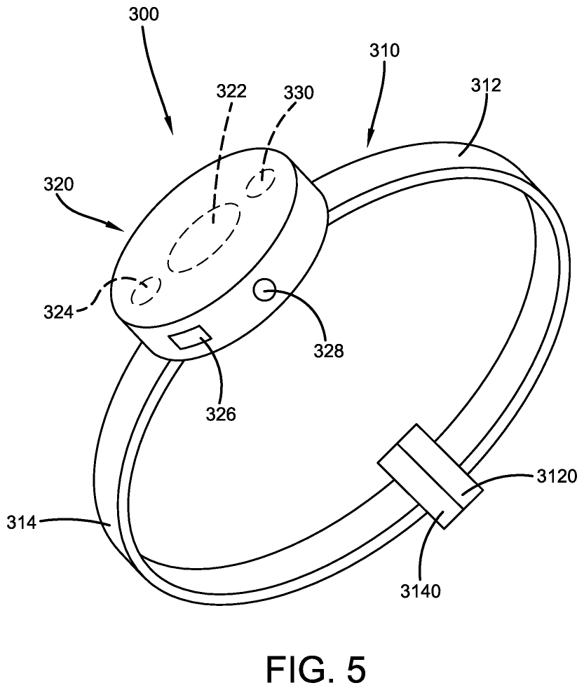

FIG. 5 illustrates a perspective view of a wrist-worn locating device 300 of one potential embodiment of the hearing aid cover 100 of the present invention. The wrist-worn locating device 300 serves as another method for a user to locate the cover 100 and hearing aid 10 if the cover 100 has been lost while attached to a hearing aid 10. The locating device 300 has a strap assembly 310 and a body 320. The strap assembly 310 is further comprised of a first strap 312 and a second strap 314. Each strap 312, 314 also includes a magnetic clasp 3120, 3140 that allows both straps 312, 314 to be attached around the wrist of a user. The strap assembly 310 is further fixedly or removably connected to the body 320 of the locating device 300. It is contemplated that at least one surface of the body 320 has a USB charging port 326 and tactile button 328 (whose function has been explained above). It is further contemplated that the USB charging port 326 allows for a battery 324 located within the body 320 to be charged. In differing embodiments, the charging port 326 may be comprised of a plurality of USB charging ports such as, but not limited to: USB-A, USB-B, Micro-B, Micro-USB, Mini-USB, USB-C, etc.

Further, in differing embodiments of the locating device 300 the body 320 may be any shape such as but not limited to: square, rectangular, circular, oval, etc. The interior of the body 320 preferably has a vibrating motor 322 as well as a transmitter beacon 330. Like the transmitter beacon 144 of the device 100, the beacon 330 of the locating device 300 contains a form of wireless transmitter or wireless communication module that allows the locating device 300 to communicate with the mobile application 200 or device 100 via a wireless electrical communication such as Bluetooth, Wi-Fi, RFID, etc. In this regard, the transmitter 330 is in electrical communication with the transmitter 144 of the device 100, such that when the locating device 300 moves closer to the device 100, the vibrating motor 322 begins to vibrate. It is further contemplated that the vibration strength of the motor 322 will increase in strength or intensity the closer the locating device 300 gets to the device 100. Therefore, the locating device 300 can be used to locate the device 100 when lost by simply walking around the area where the device 100 has been lost and relying on the increasing vibrations of the motor 322 to notify when a user is getting closer to the location of the device 100.

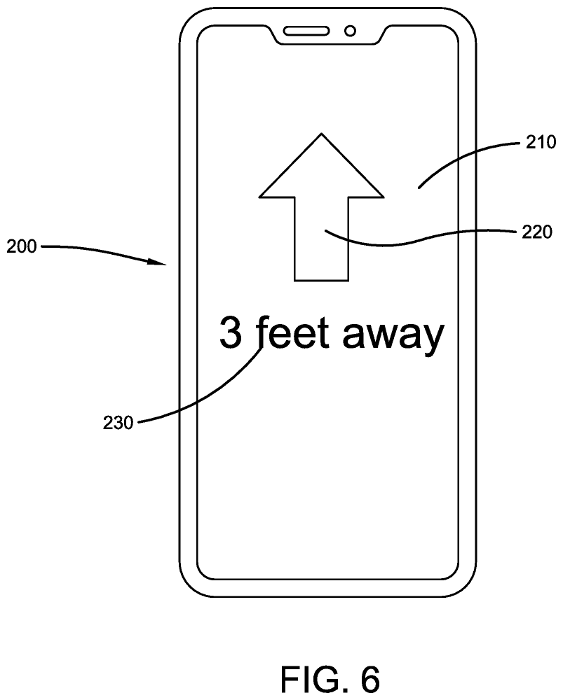

FIG. 6 illustrates a perspective view of a mobile application 200 of one potential embodiment of the hearing aid cover device 100 of the present invention. Similar to the wrist-worn locating device 300, the mobile application 200 also aids a user in finding the cover 100 if lost, especially when the device 100 is attached to a hearing aid 10. The mobile application 200 has a simple interface that can be used on any smart device. The interface includes a display that features an arrow 220 and a distance indicator 230, which can be expressed in feet, yards, meters, miles or kilometers depending on the setting of the user. Accordingly, an individual can use the mobile application 200 to locate the cover 100 when lost. As such, the transmitter beacon 144 of the device 100 communicates with the mobile application 200 such that the arrow 220 continually points in the direction of the 100 so that the individual seeking the cover and hearing aid knows in what direction to go to locate them. Further, the distance indicator 230 may also be displayed to tell a user how many feet, yards, meters, miles, kilometers, etc. they are from the cover 100. Accordingly, both features of the mobile application aid a user in finding the cover 100 and any attached hearing aid 10 if lost. In one further embodiment of the device 100, it is also contemplated that all features of the device 100 may be integrated into a hearing aid 10, such that the device also comprises a hearing aid 10 and does not use a hearing aid cover 100.

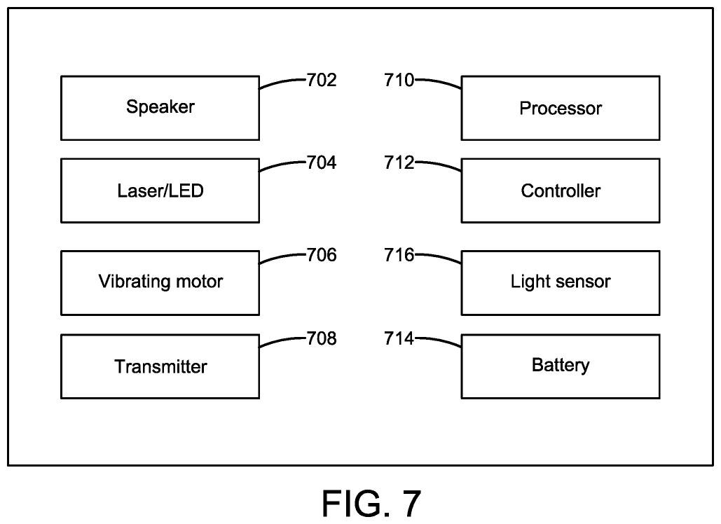

FIG. 7 provides a schematic view of the various electronic components that may be embedded in the cover and includes a speaker 702, a light, laser or LED 704, a vibrating motor 706, a wireless transmitter 708, a processor 710, a controller 712 and a battery 714. The processor 710 and controller 712 can be configured to operate the various alert features, such as the speaker 702, light 704 and vibrating motor 706 sequentially, simultaneously or on an as-needed basis. The processor 710 can also determine the amount of remaining battery life, such that it can run different components or power them off in order to conserve battery power. For example, the processor 710 and controller 712 may only operate the light feature 704 when the light sensor 716 provides information about a light level in the area where the cover and hearing aid are located so as to not waste energy of the battery 714.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved hearing aid cover”, “improved hearing aid cover device”, “device”, and “cover”, are interchangeable and refer to the improved hearing aid cover 100 of the present invention unless otherwise indicated.

Notwithstanding the forgoing, the hearing aid cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the hearing aid cover device 100 as shown in the FIGS. are for illustrative purposes only, and that many other sizes and shapes of the hearing aid cover device 100 are well within the scope of the present disclosure. Although the dimensions of the hearing aid cover device 100 are important design parameters for user convenience, the hearing aid cover device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cover device for a hearing aid, the cover device comprising:
a flexible material sized and configured to fit over a hearing aid, the flexible material having at least one opening for insertion of the hearing aid;
a connection element to secure the cover device to a frame of eyeglasses; and
at least one location finding feature.

2. The cover device as recited in claim 1, wherein the at least one location finding feature comprises a speaker for emitting an audible tone.

3. The cover device as recited in claim 2, wherein the at least one location finding feature comprises a light emitting feature.

4. The cover device as recited in claim 3, wherein the light emitting feature is one of a laser or an LED lighting feature.

5. The cover device as recited in claim 1, wherein the cover device is trackable by a mobile application downloaded to a smart device.

6. The cover device as recited in claim 1 further comprising a processor and a controller for controlling the at least one location finding feature.

7. The cover device as recited in claim 1 further comprising a wireless transmitter for transmitting and receiving an information relating to a location of the cover device.

8. The cover device as recited in claim 1, wherein the connection element is a magnetic plate or a continuous opening in the flexible material.

9. The cover device as recited in claim 1 further comprising a battery that is in electrical communication with the at least one location finding feature.

10. The cover device as recited in claim 5, wherein the mobile application comprises a directional display.

11. A cover and hearing aid combination comprising:
a hearing aid having a plurality of controls;
a cover made from a flexible material and fitting over the hearing aid, wherein the cover is comprised of an opening allowing for insertion of the hearing aid into the opening;
the opening providing access to the plurality of controls of the hearing aid;
at least one location finding feature; and
a battery for charging the at least one location finding feature.

12. The cover and hearing aid combination as recited in claim 11, wherein the at least one location finding feature comprises a light feature, a sound feature and a vibration feature.

13. The cover and hearing aid combination as recited in claim 12, wherein the light feature is connected to a light sensor.

14. The cover and hearing aid combination as recited in claim 12 further comprising a processor and a controller for controlling use of the at least one location finding feature.

15. The cover and hearing aid combination as recited in claim 11 further comprising a wireless transmitter wirelessly connecting the cover to a mobile application.

16. The cover and hearing aid combination as recited in claim 15, wherein the mobile application has a directional display for use in finding the cover and the mobile application is used with the at least one location finding feature.

17. The cover and hearing aid combination as recited in claim 12, wherein the sound emitting feature emits a tone in one of a continuous or an intermittent manner.

18. A hearing aid with a protective cover system comprising:
a hearing aid having one or more controls on an exterior surface;
a flexible cover for positioning over the hearing aid, wherein the flexible cover is comprised of at least one opening for insertion of the hearing aid within the flexible cover, the at least one opening allowing access to the one or more controls;
a battery for providing power to at least one location finding feature and an attachment feature for securing the flexible cover to a frame of eyeglasses; and
a mobile application downloaded on a smart device, wherein the mobile application is in communication with the flexible cover by a wireless transmitter.

19. The hearing aid with protective cover system as recited in claim 18, wherein the mobile application includes a directional display for the smart device to locate the flexible cover and the hearing aid, and further wherein the attachment feature is a continuous opening in the flexible cover.

20. The hearing aid with protective cover system as recited in claim 18, wherein the at least one location finding feature is controlled by a controller and a processor and comprises a sound emitting device and a light emitting device.
